(19) United States
(12) Patent Application Publication
(10) Pub. No.: US 2008/0168087 A1
(43) Pub. Date: Jul. 10, 2008

(54) System and Method for Managing Location-Independent Objects

(75) Inventors: Steven M. Repetti, Plantation, FL (US); James P. McNiel, Glenhead, NY (US); Stephen Muccione, Long Valley, NJ (US)

Correspondence Address: PAUL, HASTINGS, JANOFSKY & WALKER LLP, 875 15th Street, NW, Washington, DC, 20005, US

(73) Assignee: FIFTH GENERATION SYSTEMS, INC., Roslyn, NY (US)

(21) Appl. No.: 11/620,635

(22) Filed: Jan. 5, 2007

(51) Int. Cl. G06F 17/00

(52) U.S. Cl. 707/103 R

(57) ABSTRACT

A system and method for creation, distribution, integration, and maintenance of visual objects across various locations independent of any underlying operating systems, applications, network locations, etc. In various embodiments, information can be easily communicated, distributed, shared, and updated among various containers (e.g., browsers, applications, desktops, mobile devices, etc.) through dynamically configurable objects, regardless of where the containers are located, or what applications are running underlying the containers.

### BACKGROUND

1. Field

The embodiments described herein generally relate to object element management. More specifically, the present embodiments relate to the creation, distribution, integration, and maintenance of visual object elements across different locations within a working environment independent of any underlying operating systems, applications and/or network locations.

2. Discussion of the Related Art

Many current computer programs that operate with a graphical user interface allow users to drag and drop pictures or links from one place to another, either within a program, between programs, or within the system files of a computer or network. However, depending on what is being dragged and dropped and/or where the content is dragged from, the content, after the drag-and-drop operation may not be displayed or used in the same manner or may not retain the same functionalities after being moved. One typical example is, if a user-selectable or “clickable” link (whether a text link or an image that acts as a clickable link) is displayed in one browser window, and that link is dragged into another browser window, then the second browser window will not display the text or image, or any information within the text, the image, or the associated tags. Rather, the second browser window will execute the linkage, causing the second browser window to navigate to the website to which the text or image links. While this execution may be desirable for some systems and environments, it is severely limited in capability, adaptability and flexibility.

U.S. Patent Application Serial No. 2002/0112093 provides a method of processing information embedded in displayed content. Specifically, information is embedded within a tag associated with text or an image that is displayed in a browser. Upon a user's dragging and dropping the text or image into another browser, the embedded information can be transferred to the second browser. In conjunction with the information transfer, a particular plug-in program may be activated by the second or target browser to convert the textual input into an audible output. As explained in this application, the plug-in program is designed for a specific operating system (i.e., the Haptek plug-in workable with the Microsoft Windows OS) thereby rendering the invention to be dependent upon the target browser's underlying OS.

In light of the above, there exists a need for an improved system and method for distributing and manipulating objects from one location to another location, regardless of where each location is, or what applications are implemented in each location.

### SUMMARY

According to various embodiments, information or content is easily communicated, distributed, shared, and/or updated among various containers (e.g., browsers, applications, desktops, mobile devices, etc.) through configurable objects, regardless of where the containers are located, and/or what applications are running underlying the containers.

One embodiment can be characterized as a method for dynamically creating an object for use in a container comprising the steps of receiving an embedded element in a target container; determining a type of the embedded element; creating an object element corresponding to the embedded element based on the determined type of the embedded element; and integrating the object element into the target container. Optionally, a further embodiment includes the step of determining that the embedded element includes a unique identifier that corresponds to the created object element. In yet another optional embodiment the method further includes determining that the embedded element is a raw data element; and creating the object element from the raw data element using default object properties. In an alternative embodiment, the method further optionally includes the steps of determining that the embedded element includes a unique identifier; and using the unique identifier to locate the object element in response to the determination that the embedded element includes the unique identifier. In some embodiments the method includes the step of sending the unique identifier to an object name service, the object name service locating the object element. In other embodiments, the method further includes extracting the embedded element from a source container.

Another embodiment can be characterized as a method for distributing information embedded in various data elements across different containers, comprising extracting an embedded element from a source container; determining, in a target container, whether the embedded element is an object element; converting the embedded element into an object element if embedded element is determined not to be an object element; and integrating the object element converted from the embedded element into the target container. The method optionally further includes the step of displaying the object element in the target container. In some embodiments, the method further includes determining that the embedded element includes a unique identifier; and using the unique identifier to locate the object element. In yet another embodiment, the method optionally includes sending the unique identifier to an object name service, the object name service locating the object element. Further embodiments can optionally include the steps of determining that the embedded element is a raw data element; and creating the object element from the raw data element using default object properties.

A subsequent embodiment includes a system for information distribution across various containers, comprising a source container including one or more embedded elements; and a target container configured to receive one or more of the embedded elements from the source container, determine a type of the one or more of the embedded elements received from the source container and integrate an object element corresponding to the one or more of the embedded elements received from the source container into the target container. In some embodiments, wherein the one or more embedded elements received from the source container include a unique identifier, the system can optionally further include an object name service configured to receive the unique identifier from the target container, the unique identifier associated with the object element corresponding to the one or more of the embedded elements received from the source container. In yet another embodiment the system further includes a database coupled to the object name service, the database including a plurality of unique identifiers each corresponding to a plurality of different object elements.

### BRIEF DESCRIPTION OF THE DRAWINGS

The above and other aspects, features and advantages of various embodiments of the present invention will be more apparent from the following more particular description thereof, presented in conjunction with the following drawings, wherein:

FIG. 1A provides an overview of an independent working environment comprising one or more containers within which object elements can be created, distributed, interacted, and/or maintained according to one embodiment;

FIG. 1B is a block diagram illustrating various embedded elements within a container of FIG. 1A according to one embodiment;

FIG. 1C is a block diagram illustrating various application modules that may be included in a container of FIG. 1A according to one embodiment;

FIG. 2 is a flow diagram illustrating a process for object distribution from a source container to a target container according to one embodiment;

FIG. 3 is a block diagram illustrating a distributed relationship between a source container and a target container according to one embodiment;

FIG. 4 is a block diagram illustrating an operation-system-independent relationship between a source container and a target container according to one embodiment;

FIG. 5 is a block diagram illustrating an application (e.g., browser) independent relationship between a source container and a target container according to one embodiment;

FIG. 6 is a block diagram illustrating various ways of extracting an embedded element in the process shown in FIG. 2 according to one embodiment;

FIG. 7 is a flow diagram illustrating a process for object creation according to one embodiment;

FIG. 8 is a flow diagram illustrating a process for object integration in a target container according to one embodiment;

FIG. 9 is a block diagram illustrating various ways of creating an object according to one embodiment;

FIG. 10 is a flow diagram showing a process for object maintenance according to one embodiment;

FIG. 11 provides an diagram illustrating the process of FIG. 2 being implemented according to one exemplary embodiment;

FIG. 12 is an system diagram illustrating an object name service in accordance with one exemplary embodiment;

FIG. 13 is a flow diagram illustrating a process for tracking object elements located in a container in accordance with one embodiment; and

FIG. 14 is a flow diagram illustrating a process for facilitating a financial transaction related to an object element in accordance with one embodiment.

Corresponding reference characters indicate corresponding components throughout the several views of the drawings. One of ordinary skill in the art will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those of ordinary skill in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The embodiments described herein address the problems described in the background while also addressing other additional problems as will be seen from the following detailed description.

Before describing the figures in detail, this paragraph provides a general overview of one exemplary embodiment. Applications such as web-browsers are used by millions of people to display and share content. A web-browser allows a user to browse through content by navigating through a series of URLs. Generally, the content of each page is fed to the users by a web-server as HTML content. In accordance with the embodiments described herein, a user is able to integrate content from one location into the content that is already displayed within their browser. Thus, in accordance with the embodiments described herein, content can be integrated from, for example, one browser window and displayed along with the content that is displayed in a separate browser window. Such integration is made possible through the creation of object elements as will be described in great detail herein below. This integration process can be used to create custom web-pages, custom desktop interfaces and many other applications. Additionally, contemplated herein is a system for creating, storing and indexing content that is created for the purpose of integration into the web-browser. Such system contemplates an object name service that provides users with access to object elements that have been created by developers and can be integrated into, for example, content that is being displayed by the web-browser. The following description provides many further exemplary embodiments and variations to this specific example of content integration within a browser.

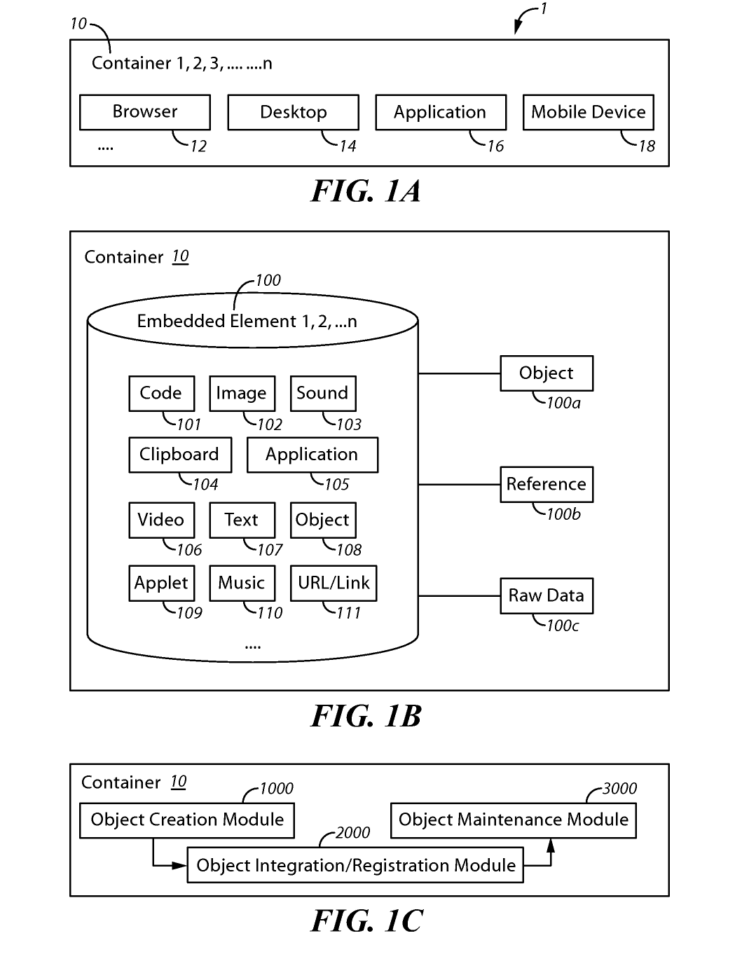

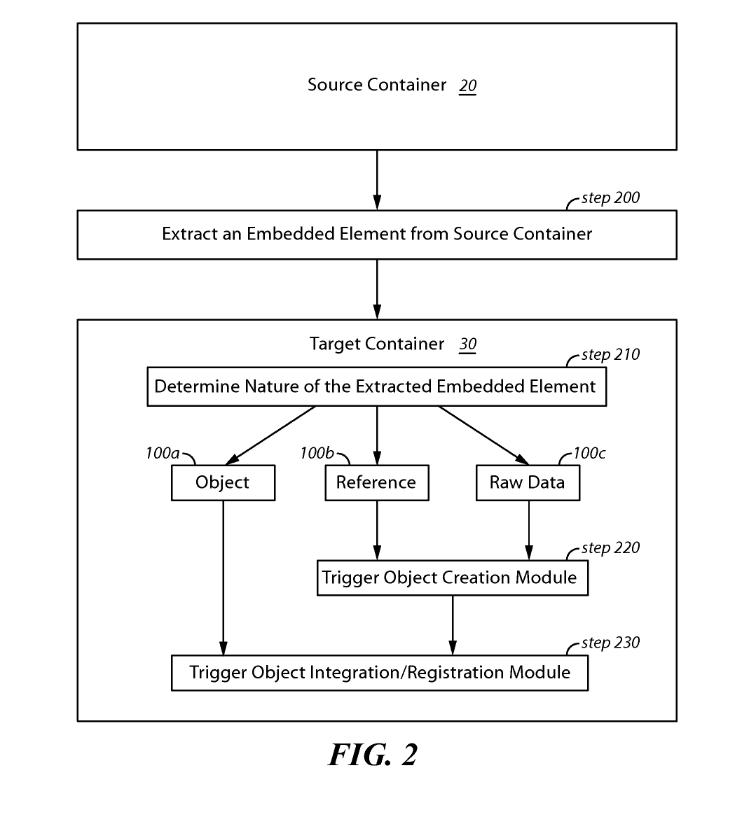

FIGS. 1A-1C give a overview of the context of the systems and processes implemented of the various embodiments described herein with reference to FIGS. 2-11.

Referring to FIG. 1A, shown is an independent working environment 1 comprising one or more containers 10 for implementing the various embodiments that will be described herein. The containers 10 are utilized to create, convert, extract, reference, insert, interact with and/or maintain content (e.g., raw data elements, object elements, reference elements, embedded elements, tracking object elements, commerce object elements and any other similar type of content). A container 10 is, for example, a browser 12, a desktop 14, an application 16, a mobile device 18, an electronic device or a software application or combination thereof. The container 10 preferably includes a user-interactive interface such that a user can easily initiate any of the processes described above.

In some embodiments, the creation and distribution of various embedded elements within the working environment 1, and the transfer of embedded elements between different containers 10 is independent of any operating systems, applications, or network architecture underlying each container 10. Specifically, embedded elements are extracted from one container 10 and distributed and integrated into another container 10 as existing object elements or are integrated into another container 10 after being converted into a new object element. The object elements are created and maintained in each container 10 and/or interacted with each other in the same container or across different containers 10. Again, in accordance with the present embodiments, the object elements and actions upon or by the object elements are not restricted by where the containers 10 are located in a network (whether local or remote) or what operating system and/or application is implementing each container 10.

Referring next to FIG. 1B, a block diagram is shown illustrating an exemplary container of FIG. 1A. The container 10 includes one or more components (also referred to herein as embedded elements). An embedded element 100 can be, for example, any of the following: code 101, image 102, sound 103, clipboard 104, application 105, video 106, text 107, object 108 (such as a Java object), applet 109, music 110, link or tag 111 (such as a uniform resource locator (URL)), or any other programmable components. In one embodiment, all embedded elements 100 or group of embedded elements fall within three types of components: an object element 100a, a reference element 100b or a raw data element 100c. That is, each embedded element or group of embedded elements can be categorized as a specific type of element: the object element 100a, the reference element 100b, or the raw data element 100c.

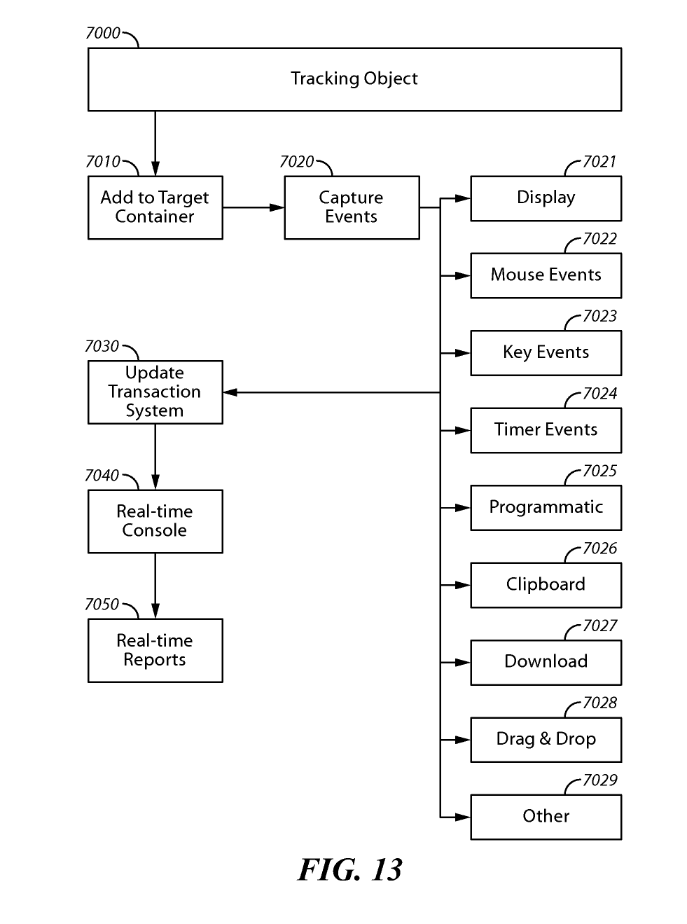

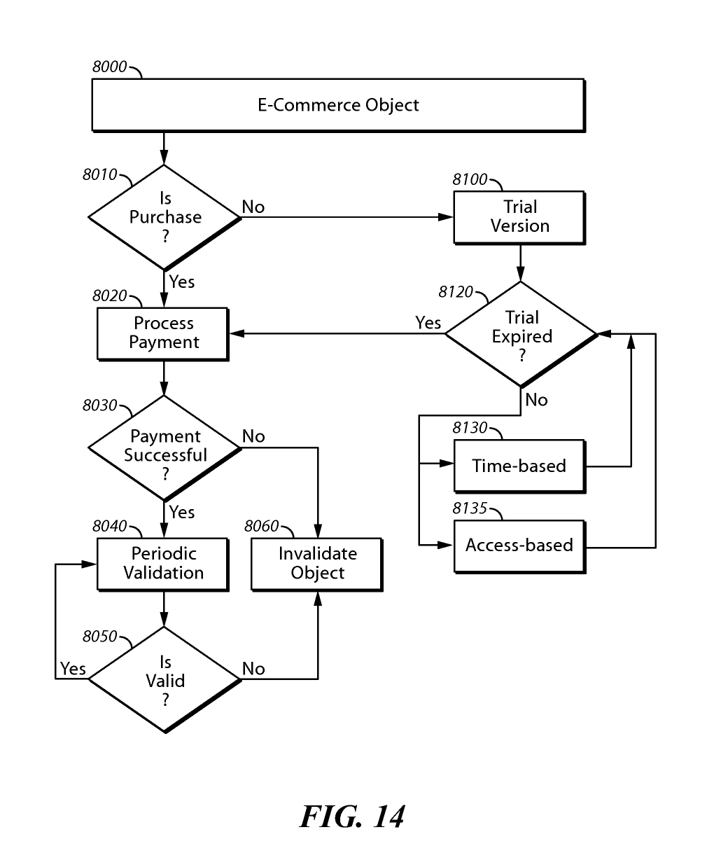

The object element 100a includes, for example, of one or more embedded elements 100 and one or more descriptive or interactive properties or attributes associated therewith. The object element 100a can be, for example, (1) predefined as a default or shared object element, or (2) customized by a particular user when the user's need for a specific type of object arises. Additionally, object elements can be specialized object elements such as a tracking object element or a commerce object element such as will be described in detail below with reference to FIGS. 13 and 14. The default object element can be used for creating an object element from one or more raw data elements. For example, a default object element can be pre-defined as shown in Table 1:

TABLE 1

| Embedded Element | Property 1 | Property 2 | . . . | Property n |
|---|---|---|---|---|
| Default Element | Default | Default | . . . | Default |
| | Value 1 | Value 2 | | Value n |

Shown below in Table 2 is an exemplary user-specified object element:

TABLE 2

| Embedded | Programmable | Programmable | | Programmable |
|---|---|---|---|---|
| Element | Property 1 | Property 2 | . . . | Property n |
| Element 1 | Value 1 | Value 2 | . . . | Value n |
| Element 2 | null | Value 2 | . . . | Value N |

The descriptive or interactive properties (also referred to as attributes) can include, for example, how the object reacts to events (such as mouse and keyboard interaction), whether object the captures and reports events, whether the object is always shown on top of other embedded elements or objects, whether the object can be minimized, how often the object updates content, whether certain embedded elements are clickable, whether an object element requires payment to be utilized, and many other properties. The previous list describes only a small number of the vast different properties that can be associated with an object element. It should be clear that different object elements can have different properties and/or different values for such properties.

One example of a user-specified object element is a complex sports information object element. The sports information object element includes, for example, at least an audio/video element and a data element. The audio/video element is capable of playing audio/video clips and the data element provides sports scores and statistics. The sports information object element also includes various properties and/or attributes that define how the object programmatically acts and how the object element responds to user interactions. It should be understood that this is one example of a complex object element, but that there is no limit to the different types of objects that can be used, created, converted, extracted, referenced, inserted, maintained, or otherwise interacted with. The complex sports object element can be easily added to a target container 30 and integrated with any other content or object elements that already currently exist in the target container 30.

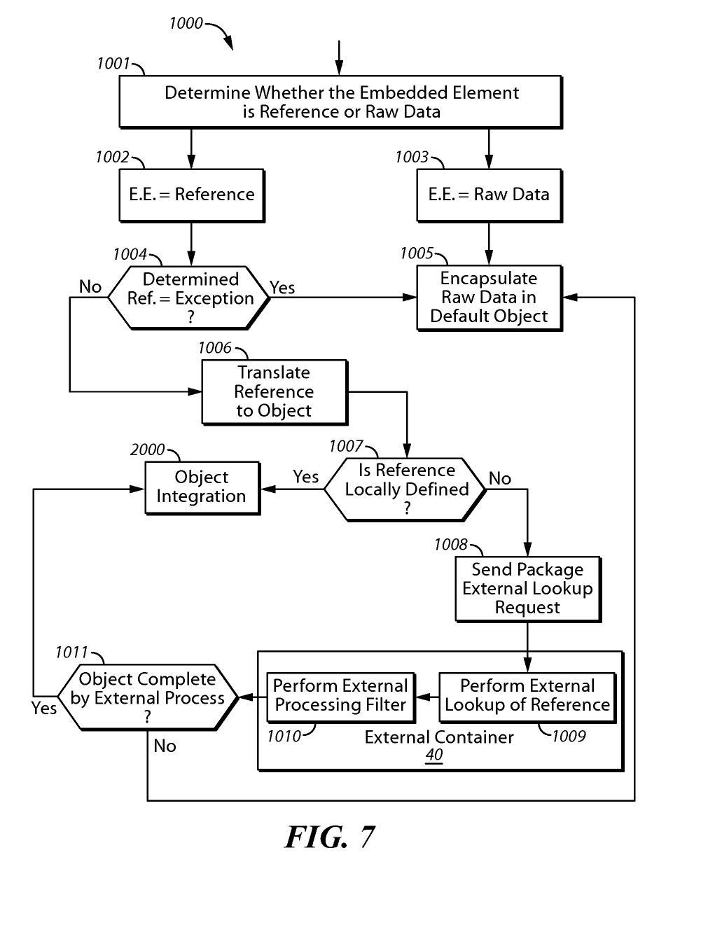

The reference element 100b includes of one or more embedded elements 100 and a unique identifier that provides a reference to certain external information. As will be described later with reference to FIG. 7, such external information can include, but is not limited to, an object element or can be used to translate the reference element 100b into a specific object element 100a. The unique identifier in each reference element 100b may comprise, for example, a unique identification value, a Uniform Resource Locator (URL) (e.g., http://www.google.com/objects or http://www.microsoft.com/picture.jpg) or a link in the case the referenced external information resides in a web page, a browser application, or on a local or remote computer. The unique identification value can be any string of numbers, letters, symbols, or combinations thereof. Examples, of a reference element 100b are shown in Table 3:

TABLE 3

| Embedded Element | ID |
|---|---|
| Element 1 | 0012345abcd |
| Element 2 | Http://www.5g.com/pictures/ |

In one embodiment, the raw data element 100c includes one or more embedded elements 100 that are neither an object element 100a nor a reference element 100b. That is, the raw data element 100c includes one or more embedded elements that do not include object properties or attributes associated therewith and do not include a reference identifier pointing to external information. One example, of a raw data element 100c is a section or block of HTML code. Another example of a raw data element 100c is a picture located on, for example, a web-site or a hard drive. When the picture does not include a recognizable reference identifier, the picture is simply the raw data element 100c. When the picture is located on, for example, a web-site, the picture will have an associated URL that can be utilized as a reference identifier, however, unless the system recognizes the specific URL as a reference identifier, the system will treat the picture as a raw data element 100c. Thus, in accordance with some embodiments, the URL will act as a reference identifier and can be used to locate external information, such as, for example, a predefined object.

Referring to FIG. 1C, a block diagram is shown illustrating various application modules that can be included in a container of FIG. 1A according to one embodiment. In various embodiments described herein, the container 10 is configured to execute one or more application modules for creating, integrating, and/or maintaining objects in the container 10. As shown in FIG. 1C, these application modules include an object creation module 1000, an object integration or registration module 2000, and an object maintenance module 3000.

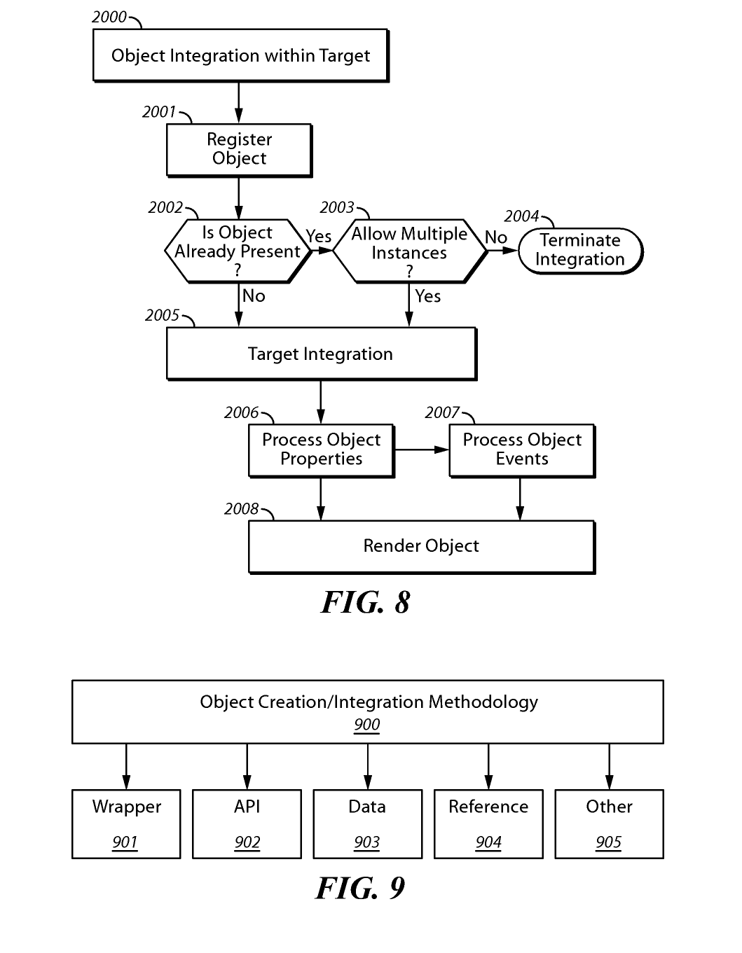

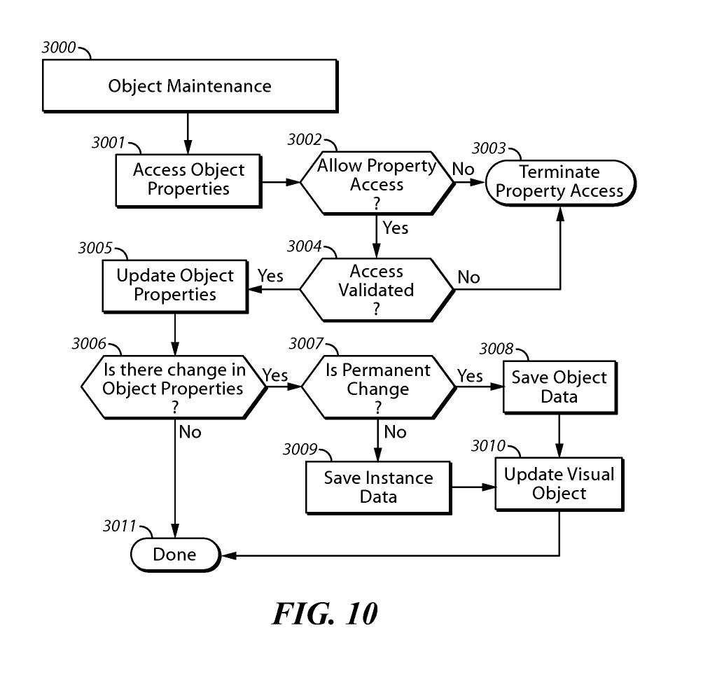

The object creation module 1000, as will be discussed in detail referring to FIG. 7, is configured to convert a reference element 100b or a raw data element 100c, into an object element 100a to be integrated into the container 10. Subsequently, the object integration module 2000 is utilized to integrate or register the created/converted object element 100a into the container 10. The object integration module will be described below in greater detail with reference to FIG. 8. The object maintenance module 3000 is configured to provide routine maintenance functionalities, such as updating and modifying object properties, for any object element 100a that is within the container 10. This module 3000 will be described later in greater detail with reference with FIG. 10.

Referring now to FIG. 2, a flow diagram is shown illustrating a process for object distribution from a source container to a target container according to one embodiment. In the process depicted in FIG. 2, an embedded element 100 is extracted to a source container 20 and is integrated into a target container 30. As will be easily appreciated by a skilled artisan, any container 10 (for example, as described with reference to FIG. 1A) can be the source container 20, or the target container 40, or both. Thus, in one embodiment, the source container 20 and the target container 40 are the same container. That is, within the single container an object element 100a is created or converted from a reference element 100b or a raw data element 100c already present in the container.

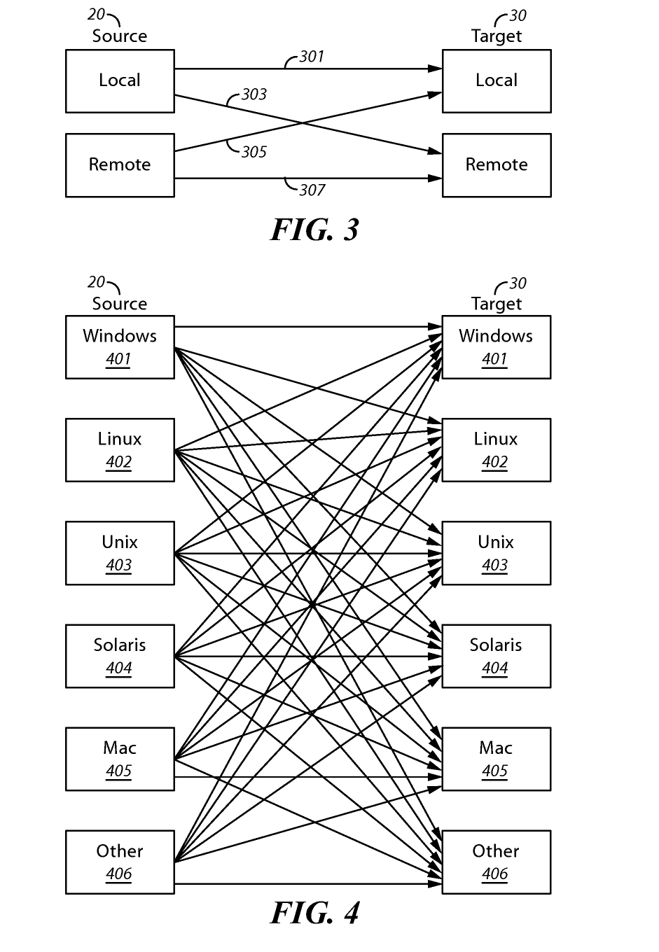

In accordance with some embodiments, the process of distributing an object element from the source container 20 to the target container 30 is independent of any specifics properties of either the source container 20 or the target container 30. Thus, the process in FIG. 2 can be performed no matter where the source container 20 and the target container 30 are located, what operating system the source container 20 or the target container is running, or what application or applications the source container 20 and the target container 30 are implemented in. This advantage of container independency provided by the some embodiments is further illustrated in FIGS. 3-5.

In operation, in step 200, an object is extracted from the source container 20 using, for example, one of the methods shown in FIG. 6. Next, in step 210, the nature of the extracted element is determined. That is, it is determined whether the extracted element is an object element 100a, a reference element 100b or a raw data element 100c. When it is determined that the extracted element is an object element 100a, the process proceeds to object integration and registration at step 230. When it is determined that the extracted element is a reference element 100b, the object creation module proceeds to create an object using the reference element 100b. A detailed description of creating an object from a reference object is described below with reference to FIG. 7.

When the extracted element is determined to be a raw data element 100c, the object creation module proceeds to create an object from the raw data element 100c. A detailed description of creating an object from a raw data element according to one embodiment is described below with reference to FIG. 7. In general, if it can not be determined whether an embedded element is an object element 100a or a reference element 100b in step 210, then the embedded element is treated as a raw data element 100c as a default designation. In this manner, most any embedded element (including, for example, a reference element, a raw data element and an object element) will be able to be converted into an object element 100a that is then integrated into the target container 30.

Referring now to FIG. 3, a distributed relationship between a source container and a target container is illustrated according to one embodiment. Within a wired or wireless network, the source container 20 and the target container 30 can have any of the following exemplary distributed relationships: local-local 301, local-remote 303, remote-local 305, or remote-remote 307.

Specifically, if the source container 20 is located locally (i.e., locally accessible from a user's perspective), the target container 30 can also reside at the same local location or can reside at a remote location. The remote location can be accessible via network protocols over a LAN, WAN, or any other wired or wireless network. For example, when the source container 20 is a browser application running on a local user computer, the target container 30 can be another browser application on this local computer or on a browser located on a different remote computer configured to be in communication with the local computer. Alternatively, when the source container 20 is located remotely, such as, for example over a network (e.g., Internet), the target container 30, which can be either local or remote to the user, communicates with the source container 20 via network protocols over a LAN, WAN, or any other wired or wireless network. Typically, this alternative configuration occurs, for example, when a user creates a web page or web application by obtaining applicable objects or other elements from various websites from the Internet in accordance with the present embodiments.

In yet another example, the source container 20 and the target container 30 can both be the same browser window, application or desktop environment. For example, a raw data element 100c extracted from the browser window (i.e., source container 20) is converted into an object element 100a and integrated into the same browser window (i.e., the target container 30) as a new object element 100a. Many other examples of source and target containers will be apparent to those of ordinary skill in the art.

Referring next to FIG. 4, a diagram is shown illustrating an operating-system-independent relationship between a source container 20 and a target container 30 according to one embodiment. More specifically, FIG. 4 illustrates that the communications between the source container 20 and the target container 30 in the object distribution process can be made regardless of what underlying operating system (OS) is used by either container. For example, if the OS underlying the source container 20 is Microsoft's Windows OS 401, the process for objection distribution can be performed whether the target container 30 is using Windows 401, Linux 402, Unix 403, Solaris 404, Mac 405, or any other OS 406. Similarly, if a Linux OS 402 is being used for the source container 20, the process will not be interrupted because the target container 30 is using Windows 401, Linux 402, Unix 403, Solaris 404, Mac 405, or any other OS 406.

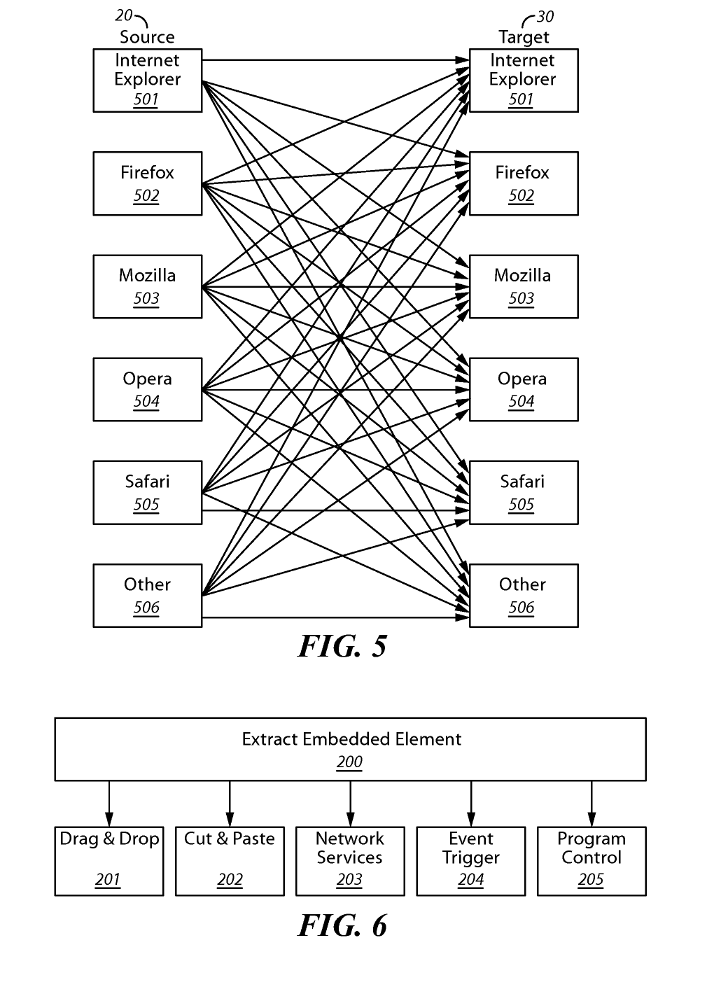

Referring to FIG. 5, an application (e.g., browser) independent relationship between a source container 20 and a target container 30 is illustrated according to one embodiment. FIG. 5 illustrates that the object distribution process of FIG. 2 can be performed regardless of what applications the source container 20 and/or the target container 30 are implemented in. That is, the process of FIG. 2 is browser independent when either the target container 30 or the source container 20 or both are implemented as a browser. As an example, an embedded element 100 can be extracted from the source container 20 that is running an Internet Explorer 501 browser, and distributed and integrated into the target container 30 that is Internet Explore 501, Firefox 502, Mozilla 503, Opera 504, Safari 505 or any other browser 506. When the source container 20 is Firefox 502, Mozilla 503, Opera 504, Safari 505, or any other browser 506, the object extraction and distribution can still be accomplished independent of the application of the target container 30.

Referring to FIG. 6, a block diagram is shown illustrating various functionalities that may be utilized to perform the step of extracting an embedded element from a source container 20 to a target container 30 in accordance with the process set forth in step 200 of FIG. 2. As described above, the process for object distribution starts with step 200 when an embedded element 100 is extracted from the source container 20. In general, an embedded element 100 can be extracted using any one of the extraction methods shown in FIG. 6, including, for example, drag and drop 201, cut and paste 202, network services 203, event trigger 204 and program control 205. Other methods of extracting an embedded element from a source container 20 may also be used in alternative embodiments.

A drag and drop 201 action is often used in computer graphical user interfaces. A common example is dragging an icon on a virtual desktop to a special “trashcan” icon to move the a file into a deletion folder. In one embodiment, the drag and drop 201 operation allows a user to select an embedded element 100 in the source container 20 and drag it into the target container 30. Cut and paste 202 is another common user interface action for transferring text, data, or files from a source to a destination. Cut and paste 202 is closely associated with graphical user interfaces that use pointing devices, however, can also be accomplished using keyboard shortcut keys. In one embodiment, the cut and paste 201 action allows a user to select and cut an embedded element 100 in the source container 20, and by moving the pointing device (such as mouse cursor), paste the embedded element into the target container 30. The embedded element will be translated into an object element 100a and integrated into the target container 30. A copy action is very similar to the cut and past action 201 and can be used in a similar manner. An embedded element 100 can also be moved from the source container 20 to the target container 30 via any one of common network services 203, such as, for example, TCPIP, RS232, Wi-Fi, PPP, ITX/SPX, CDMP, GSM, and others.

Furthermore, an event trigger 204 can be used to move an embedded element 100 from a source container 20 and integrate the embedded element into a target container 30 as an object element 100a. There are many types of event triggers 204 that take place in a computing environment. For example, when a user clicks a button in a music player, when a user interacts with a pull down menu within a browser or when a clock changes a minute or second value are a few examples of an event trigger 204 that can be used to move an embedded element 100 from a source container 20 into a target container 30 as an object element 100a.

Still further, program control 205 can be used to move an embedded element 100 from a source container 20 into a target container 30 as an object element 100a. For example, a program that is currently running could programmatically extract an embedded element from a source container 20 and add an object element to a target container 30. Alternatively, for example, a program could open a new target container 30, extract an object element or embedded element from a source container 20 and integrate the selected object element or embedded element into the new target container 30 entirely programmatically.

As described above with reference to FIG. 2, after the embedded element 100 is extracted from the source container 20 and delivered to the target container 30, the object distribution process proceeds to step 210 at which the target container 30 determines the nature of the extracted element 100 (i.e., whether the element 100 is an object element 100a, a reference element 100b, or a raw data element 100c). When the embedded element is determined to be either a reference element 100b or a raw data element 100c, the object distribution process continues to perform step 220. In step 220, the object creation module 1000 running on the target container 30 is triggered and the process continues as shown in FIG. 7. However, when the embedded element is determined to be an object element 100a or an object element 100a is created as a result of the object creation module 1000, the general process of FIG. 2 proceeds to trigger the object integration and/or registration module 2000 at step 230. As a consequence, the target container 30 executes the process shown in FIG. 8 and integrates the object element 100a into the target container.

Referring now to FIG. 7, a flow diagram is shown illustrating a process for object creation according to one embodiment. That is, in one embodiment, the object creation module 1000 is configured to perform some or all of the steps in the flow diagram shown in FIG. 7. Starting at step 1001, the target container 30 determines whether a non-object embedded element 100 is a reference element 100b or a raw data element 100c. When, at step 1003, the embedded element 100 is determined to be a raw data element 100c, the object creation process continues to step 1005. In step 1005, the target container wraps or encapsulates the raw data element 100 within a default object that is pre-defined for purposes of converting a raw data element 100c into an object element 100a. For example, Table 4 below shows the default object before encapsulation:

TABLE 4

| Embedded Element | Property 1 | Property 2 | . . . | Property n |
|---|---|---|---|---|
| Default Element | Default | Default | | Default |
| | Value 1 | Value 2 | | Value n |

After step 1005, the newly created object is, for example, as shown in Table 5. It should be understood that the properties before and after the conversion may be different and the values for each of the properties may change.

TABLE 5

| Embedded | | | | |
|---|---|---|---|---|
| Element | Property 1 | Property 2 | . . . | Property n |
| Raw Data | Default Value | Default Value 2 | | Default Value n |
| Element 100 | 1 | | | |

Referring back to FIG. 7, when the embedded element 100 is determined to be a reference element 100b at step 1002, the process proceeds to step 1004. In step 1004, the target container 30 determines whether the reference element 100b represents an exception that cannot be translated into an object element 100a using the reference element's 100b unique identifier, and thus should be treated as a raw data element 100c. If the unique identifier is not recognized or the system can not find an object element 100a associated with the unique identifier, the process proceeds back to step 1005 and the target container 30 performs the translation of the reference element 100b just as if the embedded element was a raw data element 100c element. However, when the reference element 100b is not an exception, the process continues to step 1006. In step 1006, the target container 30 translates a reference element 100b into an object element 100a that will be integrated into the target container 30. The process of integration is described in greater detail with reference to FIG. 8.

More specifically, translation of the reference element 100b can be done through steps 1007-1011 of FIG. 7. At step 1007, the target container 30 determines whether the extracted reference element 100b is defined locally. In other words, the target container 30 will search locally to determine whether there is already a defined object element 100a corresponding to the reference element 100b, and if so, the object creation process can proceed directly to the object integration module 2000. In one example, a local database may contain a list of unique identifiers. Within the local database, each unique identifier is associated with a pointer to a memory location where the object element 100a that corresponds to the reference element 100b is stored in memory. The object element 100a can then be integrated into the target container 30 as described, for example, in FIG. 8.

When there is no such object locally defined for the reference element 100b, at step 1008 an external lookup request will be generated. In step 1008, the external lookup request includes at least the unique identifier of the reference element 100b. As described above, the unique identifier is, for example, a URL, a web link, an index key, or other character string (e.g., alpha, numeric, symbolic, or combination thereof). The external lookup request is then sent to an external container 40, for example, via a programmable process or a network service. The external container 40 is a container different from the target container 40 and in various embodiment is, for example, any one of the plurality of containers 10 in the working environment 1 as shown in FIG. 1A. In one embodiment, the external container 40 is also the source container 20. For example, the external container 40 can be a web server, an application server, or combination thereof. As shown in FIG. 7, steps 1009-1010 are performed in the external container 40. At step 1009, the external container performs a look up for external information associated with the unique identifier of the reference element 100b. When the unique identifier is an index key, the external container 40 will refer to an index or directory for external information corresponding to that particular index key. If the identifier is a web link or URL, the external container 40 may link to the particular web page for the external information (e.g., an object element 100a). Alternatively, the URL may be indexed to point to an object that is directly accessible by the external container 40. Still alternatively, the URL may simply be used as a reference to locate an object that is stored, for example, in a local or remote memory location from the server. The exact memory location may not be known to the web server, but may be known to a different web or application server. For any of the above cases, if no exact match is found, the external container 40 may repeat the search process based upon variations of the index key, URL or web link and to the extent a partial match may be found, the partial match can optionally be utilized to access an object element 100a.

The search results from step 1009 are next provided to an external processing filter within or accessible to the external container 40 at step 1010. The purpose of step 1010 is to perform additional filtering or processing of the search results pursuant to one or more pre-defined rules. The extent and number of the pre-defined rules will vary from one application to another. For example, in the event multiple matches are found (i.e., different versions of the external information), which match or version should be used will be determined by one of those rules. Other determining factors, including access control, authorized usage, default handling, and integration, are also optionally defined by each of the rules. Step 1010 can optionally be removed from the process. Similarly, one or more of the steps shown in any of the flow diagrams described herein may be optionally removed or other steps added depending upon a specifically desired implementation. Once the searched external information is returned to the target container 30, the container 30 determines whether the information is sufficient and authorized for creating an object element 100a corresponding to the reference element 100b, as shown at Step 1011. If the information is determined to be sufficient and authorized, the process continues to the object integration module 2000. Otherwise, the process goes back to step 1005 for encapsulating the reference element 100b as if it is a raw data element 100c.

After an object element 100a is created from the non-object embedded element, whether it is a reference element 100b, a raw data element 100c or it is an existing object element 100a, the object element 100a will be integrated into the target container 30 following a process provided in FIG. 8 according to one embodiment. In the process shown in FIG. 8, the object integration module 2000 starts with an object registration process 2001 that includes steps 2002-2004. At step 2002, the target container 30 determines whether the object element 100a already exists in the target container 30. When the object element 100a already exists, in step 2003, the target container 30 further determines whether multiple instances of the object element 100a are allowed pursuant to a set of pre-defined rules governing such object element 100a in the target container 30. If multiple instances of the object element 100a are not allowed, the object integration process will be terminated at step 2004. If multiple instances of the object element 100a are allowed, or the created object element 100a is determined to be new and not already present in the target container, then the target container 30 will start integration of the object element 100a into the container at step 2005.

In operation, when further integrating the object element 100a into the target container 30 the process continues with steps 2006 and 2007. As shown in step 2006, the properties of the object element 100a are processed. Similarly, at step 2007, if the object contains event properties, the object events are processed within the target container 30.

As an option in addition to object integration, the object element 100a within the target container 30 can be dynamically configurable to help afford users greater flexibility in configuring an object element for a specific purpose or user and to help easier movement of objects across different containers. For example, an object element's 100a properties can be updated or changed by a user and object events can be added or modified for the object element 100a. This option can be presented to a user during integration or alternatively after the object has been integrated.

Following in step 2008, the object element 100a is rendered within the target container 30. In one embodiment, the object element 100a is integrated within the target container 30 and is rendered as a visual object such that all or a portion of the object is displayed to a user. Alternatively, the object element 100a is not a visual object, however, is integrated into the target container 30.

Referring next to FIG. 9, a block diagram is shown illustrating various ways for creating an object element. There are many different operations that can be used to create an object element 900, including, for example, wrapping 901, application programmable interface (API) 902, data definition 903, reference 904, and other methods 905 as will be recognized by one of ordinary skill in the art.

The wrapping 901 function can be used to create an object element 100a from, for example, a raw data element 100c. The API technology 902 provides a collection of programming functions, objects, libraries, data and other elements or components for the user to program and customize a process for creating an object element 100a. The data definition 903 allows the object element to be defined and created from a set of data that corresponds to object properties, events and content. Object elements can also be created and integrated by reference, such as, for example, by using the method described in FIG. 7.

Because the properties of an object element may change from time to time, or it may be desirable to allow a user to change object properties, the container housing the object element (i.e., the target container) may be configured to execute a local or remote object maintenance module in order to update and/or maintain the object elements within the container. FIG. 10 is a flow diagram of a process for object maintenance that may be executed utilizing an exemplary object maintenance module 3000 in accordance with one embodiment. As shown in FIG. 10, the properties of a particular object element 100a are requested for access as a result of user intervention or a programmed trigger within the container (see step 3001). Whether the access should be granted may be determined by either the object element 100a itself or the container housing the object at step 3002. If the request for access of step 3001 is denied in step 3002, then the object maintenance process will be terminated at step 3003. If, on the other hand, the request for access to the properties is granted in step 3002, then the requested access will be validated in step 3004. That is, the object element to be accessed or the container housing the object element will verify whether the user intervention or programmed trigger that caused the access request has been authorized for accessing such requested particular properties. Again, if not authorized, then the maintenance process is terminated at step 3003. When the access request passes the validation step 3004, the requested object properties will be accessible for update or inspection at step 3005.

Based upon the property update, the object element or the target container 30 further determines whether there is any change made to the object element properties at step 3006. If no change is detected, the maintenance process is complete, as shown in step 1011. However, if any change is detected, the process proceeds to step 3007 at which the object element or the container housing the object element determines whether the detected change is limited to the current instance of the particular object element subject to the maintenance or whether the change causes permanent impact on any future instances of the subject object element in the container. When the change is only limited to the current object element instance, the updated data will only be saved for this particular object element instance at step 3009 before completing the object maintenance at step 1011. When the change, however, is permanent and affects the entire object element or even related object elements the updated data will be saved as a permanent data change at step 3008, and then update the underlying object element and/or other affected object elements, prior to completing the maintenance process at step 1011.

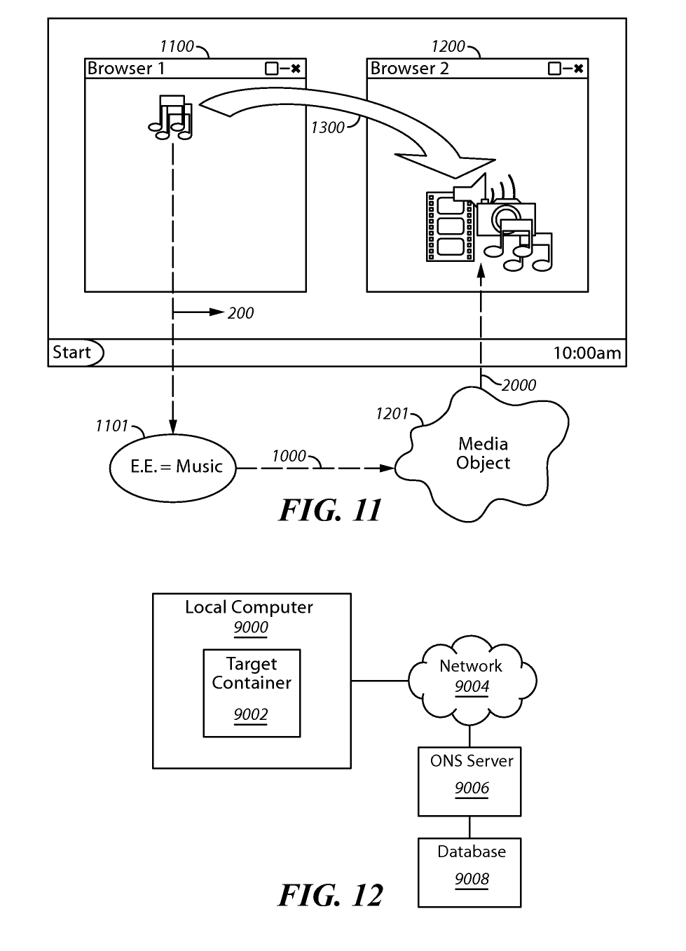

A specific example of the object distribution process between different containers will now be described with reference to FIG. 11. As shown in FIG. 11, the source container and target container are embodied as two different browsers, namely, the source browser 1100 and the target browser 1200. The object distribution process between the source browser 1100 and the target browser 1200 proceeds when a user can, for example, uses a mouse, to click and select an embedded element (e.g., the music element 1101) from the source browser 1100.

Next, the user drags and drops the music element 1101 into the target browser 1200 as shown by the arrow 1300, and ultimately, a media object element 1201 is displayed in the target browser 1200. This user interaction may be accomplished as follows. First, the user-selected embedded element (e.g., the music element 1101) is extracted, for example, by use of any one of the extraction methods 200 shown in FIG. 6. Second, the music element 1101, if determined to be a non-object element for use in the target browser 1200, proceeds through the object creation process 1000, such as, for example, the object creation process described above with reference to FIG. 7. This process forms a new object element (i.e., the media object element 1201) that is ultimately rendered or displayed in the target browser 1200. Finally, the media object element 1201 will be integrated into the target browser 1200 following, for example, the process described above in FIG. 8. During this process, the media object 1201 can be created as a default object element within the target browser 1200, or can be specifically customized by the user. For example, the embedded music element 1101 may be a raw data element such as a song or soundtrack, without any property information or reference associated therewith. When it is extracted to the target browser 1200, the music element 1101 is wrapped to create the media object element 1201, which includes properties or attributes to further describe or program the piece of song or soundtrack that was the music element 1101. Such properties may include the song title, author, or other copyright information, a function for downloading, a function for editing, a flash or graphic display corresponding to the melody, related video or movie clip, and so forth. The media object element 1201 can also be associated to various events, such as an action of opening the source browser 1200 may trigger playing the embedded music element 1101.

As an option, the properties and associated events of a media object 1201 are dynamically configurable so that a user can control and personalize the media object 1201. As an example, a user can modify the media object element 1201 by deleting from its properties a downloading function. In that way, any music element embedded within the media object element 1201 will become non-downloadable. Alternatively, if a user only wants to disable the download function for a particular music element embedded within a the media object 1201, the user can do so by updating the property value of that particular media object. As can be seen from this example, in some embodiments, the information or data distribution through transferring individual objects between different containers that are independent of each other becomes very easy and flexible. In some embodiments, the data or information management (e.g., organization, maintenance, real-time updates, etc.) within each container itself, has been greatly enhanced due to the object configurability.

Referring next to FIG. 12, an exemplary system diagram is shown illustrating an object name service in accordance with one embodiment. Shown is a local computer 9000, a target container 9002 running on the local computer 9000, a network 9004, an object name service (ONS) server 9006 and a database 9008.

The local computer 9000 is connected to the ONS server 9006 through the network 9004. The network 9004, is for example, a LAN, a WAN, the Internet, or an other such wired or wireless network. In one example, the local computer 9000 can be implemented as a computer, a cellular phone or a PDA that is connected through a wired or wireless telecommunications network to the ONS server 9006.

The ONS server 9006 is, for example, a web server, an application server or any combination thereof. The ONS server 9006 is coupled to the database 9008. The database 9008 resides locally at the ONS server 9006 in accordance with one embodiment or alternatively is accessible by the ONS server through standard database access protocols such as are known in the art. In one particular embodiment, the ONS server 9006 is a web server that provides access to web pages through a browser running on the local computer 9000. In this embodiment, the ONS server 9006 provides embedded elements (i.e., object element 100a, reference elements 100b, or raw data elements 100c) to the web browser. In this example, a web browser running on the local computer 9006 can potentially act as a source container.

Following this example, in operation a user may drag and drop an embedded element from the source browser that is displaying information from the ONS server to the target container 9002. Alternatively, a different web server may provide information to a source container. The target container 9002 is, for example, a desktop, another browser window or other application. The target container may already contain one or more embedded elements and/or object elements. If the embedded element is an object element 100a, the object element will be integrated into the target container 100a, for example, such as is described with reference to FIG. 8. However, if the embedded element is a reference element 100b, a unique identifier associated with the reference element 100b will be sent to the ONS server 9006. Upon receipt of the unique identifier, the ONS server 9006 accesses the database 9008 using the unique identifier to locate an object element 100a. The object element 100a may be stored in the database 9006 or another memory location that corresponds to the unique identifier and is directly accessible by the ONS server 9006. Alternatively, the database 9008 may have a remote location pointer associated with the unique identifier. For example, the object element 100a may be located on a separate remote web server. In this instance, after accessing the database to find the remote location pointer associated with the unique identifier, the ONS server 9006 sends a message to the separate remote web server requesting the object element to be provided to the target container 9002 running on the local computer 9000. In any instance, unless there is some type of exception, after sending the unique identifier to the ONS server, the target container 9002 will receive an object element 100a that will be integrated into the target container 9002.

Thus, the ONS server 9006 can operate in a variety of ways and can operate as a web server and/or as a service that is utilized by the target container to locate and/or provide object elements that are associated with a unique identifier of a reference element 100b. In this manner, all types of object elements can be registered with the ONS server and either stored locally at the ONS server (either in the database 9008 or other memory location) or stored remote from the ONS server. The database 9008, in one embodiment, contains entries of unique identifiers that have an associated object element. The database 9008 also contains a location pointer that is associated the unique identifier in order to point to the location where the object element is stored. Generally, each unique identifier will point to a different location, however, multiple identifiers can also point to the same location and identify the same object element. In yet another embodiment, the unique identifier is a URL. In this embodiment, the URL can then be associated with a location of an object element (e.g., locally or remotely stored from the ONS server 9006) or can be used itself to point to a location for retrieving an object. Thus, the ONS server 9006 is very flexible in how unique identifiers are processed and how and where object elements are stored.

Referring to FIG. 13, a flow diagram is shown illustrating a process for tracking objects within a container in accordance with one embodiment.

In step 7010, a tracking object element is added to a target container. The tracking object element is a specialized object element that includes a unique identifier such as described above with reference to FIG. 1B. Additionally, the tracking object element includes an event handler that captures events that take place within the object or object container. In step 7020, any events that the event handler is programmed to handle are captured by the event handler. The events include, for example, displaying the tracking object element 7021 (or an embedded element of the tracking object element), a mouse event 7022, a keystroke event 7023, a timer event 7024, a programmatic event 7025, copying content to the clipboard 7026, a downloading content 7027, a drag and drop event 7028, and other similar events 7029.

Next in step 7030, the captured events are sent to a transaction tracking system (e.g., the ONS) which updates a transaction log. The captured events are sent to the transaction tracking system, for example, either via the event handler of the object or an event handler within the target container. This creates a transaction record for any of the events that are desired to be tracked based upon the needs of the specific system implemented.

Optionally, in step 7040, a real-time console reads the updated transaction log and provides information to a user. Additionally, real-time reports can be generated from the console in step 7050. Current systems have the ability to track navigation of users between various web-sites based upon a user clicking on a web-link by logging the request for the web-page. However, the current system has the ability to track any event for a specific object element located within a target container and optionally also provide real-time updates and reports. This system allows for unprecedented ability to track interaction with content at an object specific level. Tracking object elements may be self contained or integrated as a property of any other object element.

Referring to FIG. 14, a flow diagram is shown illustrating a process for facilitating a financial transaction related to a commerce object in accordance with one embodiment.

A commerce object element is a specialized object element where a back end system (e.g., the ONS) can limit or prevent access to the commerce object element. A commerce object element includes a unique identifier and in some embodiments, the commerce object element will also include the event handler and thus be considered a tracking object element. In operation, the commerce object element will periodically contact a back end system and request permission to run. The process shown in FIG. 14 thus, illustrates a process of determining if the object element is allowed to run.

In step 8010, a determination is made whether the commerce object element is going to be purchased. For example, a user sends a request to purchase the object element. If so, the payment will be processed in step 8020. If not, the commerce object element can include a trial version 8100. Following, in step 8120, a determination is made whether a trail period has expired. The trial period can expire based upon a time-based 8130 or access based 8135 calculation. The time based 8130 can be set to expire at a certain date and time or can be set to expire for an amount of time (e.g., 2 days) after the object has been added to a target container. For example, a commerce object can be added to a target container. After 15 days, the commerce object will invalidate unless the user decides to purchase the object. As another example, the commerce object element can include an access-based 8135 trial. A user can access the commerce object element for a determined number of times before the object will invalidate. For example, a user could view a complex sports object 30 times before the complex sports object would invalidate. Preferably the commerce object element is a tracking object element such that any type of event can be used for the access-based 8135 trial.

Once a trial period has expired 8120, the commerce object element remains validated if the user decides to purchase the commerce object element. In step 8130, a determination is made whether a payment has been successfully received. If not, the commerce object element will be invalidated and will not continue to function. If payment is successful, the object continues to function and optionally a periodic validation takes place in steps 8040 and 8050.

The method described in FIG. 14 allows for developers to create object elements that can be added to a target container while providing the developer with monetary compensation. This allows, for example, developers to create complex objects that users can include in a web-page or desktop. The developers then can receive compensation for those objects that others users feel are valuable. In one embodiment, the ONS server 9006 will store a library of complex objects that developers have created. the ONS server 9006 can be coupled to a payment transaction system that conducts the payment processing. This allows for developers to create objects and submit them to the ONS server 9006 and not have to process any payments themselves. For example, developers could have a personal account that is linked with any objects that they have developed and submitted to the ONS server 9006. Anytime a user pays for their object the developer would receive all or a portion of the payment.

Embodiments described herein with reference to FIGS. 1-14 may be implemented using a computer that includes a central processing unit such as a microprocessor, and a number of other units interconnected, for example, via a system bus. Such a computer may also include, for example, a Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the computer to a communication network (e.g., a data processing network) and a display adapter for connecting the bus to a display device. The computer 9000 shown in FIG. 12 can be implemented in this manner.

The various embodiments may be implemented on one or more of the following exemplary devices: a personal computer, a laptop, a tablet PC, a Personal Digital Assistant (PDA), cellular telephone, and other electronic devices. In accordance with some embodiments, the various aspects described above may be implemented using computer programming or engineering techniques including computer software, firmware, hardware or any combination or subset thereof. Any resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network. In addition, one of ordinary skill in the art of computer science will be able to combine the software created as described with appropriate general purpose or special purpose computer hardware, Personal Digital Assistant (PDA) hardware, cellular telephone hardware or other electronic hardware to create a computer system or computer sub-system embodying the method of the invention.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What is claimed is:

1. A method for creating an object element for use in a container, comprising:
receiving an embedded element in a target container;
determining a type of the embedded element;
creating an object element corresponding to the embedded element based on the determined the type of the embedded element; and
integrating the object element into the target container.

2. The method of claim 1, further comprising determining that the embedded element includes a unique identifier that corresponds to the created object element.

3. The method of claim 1, further comprising:
determining that the embedded element is a raw data element; and
creating the object element from the raw data element using default object properties.

4. The method of claim 3, wherein said default object properties comprises one or more pre-defined properties, each having a default value.

5. The method of claim 1, further comprising:
determining that the embedded element includes a unique identifier; and
using the unique identifier to locate the object element in response to the determination that the embedded element includes the unique identifier.

6. The method of claim 5, further comprising sending the unique identifier to an object name service, the object name service locating the object element.

7. The method of claim 1, further comprising extracting the embedded element from a source container.

8. A method for distributing information embedded in various data elements across different containers, comprising:
extracting an embedded element from a source container;
determining, in a target container, whether the embedded element is an object element;
converting the embedded element into an object element if embedded element is determined not to be an object element; and
integrating the object element converted from the embedded element into the target container.

9. The method of claim 8 further comprising displaying the object element in the target container.

10. The method of claim 9 wherein the target container includes a plurality of visual object elements, and wherein said object element converted from the embedded element is displayed along with the plurality of visual object elements.

11. The method of claim 8, wherein the step of converting the embedded element into an object element further comprises:
determining that the embedded element includes a unique identifier; and
using the unique identifier to locate or retrieve the object element.

12. The method of claim 11, further comprising sending the unique identifier to an object name service, the object name service locating the object element.

13. The method of claim 8, wherein the step of converting the embedded element into an object element further comprises:
determining that the embedded element is a raw data element; and
creating the object element from the raw data element using default object properties.

14. The method of claim 8, wherein the embedded element is a reference element associated with a complex object located in a remote storage location.

15. A system for information distribution across various containers, comprising:
a source container including one or more embedded elements; and
a target container configured to receive one or more of the embedded elements from the source container, determine a type of the one or more of the embedded elements received from the source container and integrate an object element corresponding to the one or more of the embedded elements received from the source container into the target container.

16. The system of claim 15, wherein the target container is further configured to render the object in the target container as a visual object.

17. The system of claim 15, wherein the one or more embedded elements received from the source container are extracted from the source container using a drag and drop operation, a cut and paste operation, a network service operation, an event trigger operation or a program control operation.

18. The system of claim 15, wherein the one or more embedded elements received from the source container include a unique identifier, the system further comprising an object name service configured to receive the unique identifier from the target container, the unique identifier associated with the object element corresponding to the one or more of the embedded elements received from the source container.

19. The system of claim 18 further comprising a database coupled to the object name service, the database including a plurality of unique identifiers each corresponding to a plurality of different object elements.

20. The system of claim 15 wherein the target container is further configured to create the object element corresponding to the one or more of the embedded elements received from the source container.
